(19) United States
(12) Patent Application Publication
(10) Pub. No.: US 2006/0150679 A1
(43) Pub. Date: Jul. 13, 2006

(54) Bonding method for vent pipe of display panel

(75) Inventors: Akihiro Fujimoto, Miyazaki (JP); Yasuhiro Matsuoka, Miyazaki (JP); Hironori Ishimaru, Miyazaki (JP); Minoru Fukui, Miyazaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 11/327,312

(22) Filed: Jan. 9, 2006

(30) Foreign Application Priority Data
Jan. 13, 2005 (JP) 2005-006611
Sep. 30, 2005 (JP) 2005-287795

(51) Int. Cl. C03C 27/00; C03B 27/04

(52) U.S. Cl. 65/42; 65/43

(57) ABSTRACT

The bonding method for a vent pipe of a display panel includes the step of preparing the bonding member on the periphery of the flange portion of the vent pipe, the step of interposing a buffer member made of a low-melting point glass flit having a softening temperature higher than that of the bonding member between a contact face to the display panel of the flange portion of the vent pipe and the display panel, and, in a state in which the flange portion of the vent pipe is pressed onto the display panel face by a pressing member so that the vent pipe is fixed, the step of heating the bonding member and the buffer member to a temperature to be softened so that the flange portion of the vent pipe is bonded to the display panel through the fused bonding member.

### CROSS-REFERENCE TO RELATED APPLICATION

This application is related to Japanese Patent Applications No. 2005-006611 filed on Jan. 13, 2005 and No. 2005-287795 filed on Sep. 30, 2005, on the basis of which priorities are claimed under 35 USC §119, the disclosure of these applications being incorporated by reference in their entirety.

### BACKGROUND OF THE INVENTION

1. Field of the Invention

The present invention relates to a bonding method for a vent pipe of a display panel, and more particularly, concerns a bonding method for a vent pipe that is attached to a display panel such as a PDP (plasma display panel) so as to draw an impurity gas from a charging space inside the panel and fill the charging space with a charging gas.

2. Description of the Related Art

Conventionally, with respect to display panels such as PDPs, a substrate on the front face side and a substrate on the back face side are placed face to face with each other, and the peripheral portion is sealed so that a charging space is formed.

Normally, when such a display panel is manufactured, a vent hole is formed on the substrate on the back face side, and upon carrying out a sealing process for heating and sealing the substrate on the front face side and the substrate on the back face side, a vent pipe (also referred to as an exhaust pipe or a chip pipe) made of glass is bonded thereto in a manner so as to cover the vent hole. Then, an impurity gas is drawn from the inside of the panel through the vent pipe and the inside of the panel is filled with a charging gas, and the vent pipe is then fused and cut so as to block the vent path of the vent pipe so that the charging space is closed.

With respect to the vent pipe, for example, a structure has been known in which: a flange portion having a virtually flat end face is formed on one end of the vent pipe, with a bonding member of the vent pipe being fitted to the periphery thereof, so as to form an integral structure (see Japanese Patent Application Laid-Open No. 2001-307635).

In the case when the vent pipe has the above-mentioned structure, the bottom face of the flange portion having a virtually flat end face of the vent pipe is directly made in contact with the glass substrate, and for example, when a foreign matter is sandwiched between these, the end face of the vent pipe tends to have scratches when a positional deviation or the like occurs after the pressing process by a pressing tool to cause the subsequent leak in the display panel in the succeeding thermal treatment.

The present invention has been devised so as to solve the above-mentioned problem, and provides a structure in which a buffer member is placed on the contact face to the display panel of the flange portion of the vent pipe so as to make the vent pipe free from cracks or the like.

### SUMMARY OF THE INVENTION

The present invention relates to a bonding method for a vent pipe of a display panel in which, with a tube-shaped vent pipe having a flange portion with a virtually flat end face at one end thereof being positioned to a vent hole of a display panel, the vent pipe is bonded thereto through the fused bonding member, is provided with the steps of: preparing the bonding member on the periphery of the flange portion of the vent pipe; interposing a buffer member made of a low-melting point glass flit having a softening temperature higher than that of the bonding member between a contact face to the display panel of the flange portion of the vent pipe and the display panel; and in a state in which the flange portion of the vent pipe is pressed onto the display panel face by a pressing member so that the vent pipe is fixed, heating the bonding member and the buffer member to a temperature to be softened so that the flange portion of the vent pipe is bonded to the display panel through the fused bonding member.

In accordance with the present invention, since a buffer member is placed on the contact face to the display panel of the flange portion of the vent pipe, this buffer member exerts a buffering function so that the vent pipe is made free from occurrence of cracks and the like.

### BRIEF DESCRIPTION OF THE DRAWINGS

FIGS. 1(a) to 1(c) are explanatory drawings that show a bonding method for a vent pipe of a display panel in accordance with Embodiment 1 of the present invention;

FIGS. 2(a) and 2(b) are explanatory drawings that show a bonding method for a vent pipe of a display panel in accordance with Embodiment 1 of the present invention;

FIG. 3 is an explanatory drawing that shows a bonding method for a vent pipe of a display panel in accordance with Embodiment 1 of the present invention;

FIG. 4 is a plan view that shows a state in which the vent pipe 1 and the display panel are sandwiched by the clip 15;

FIG. 5 is a graph that shows the temperature profile of the sealing and exhausting processes of the display panel of Embodiment 1;

FIG. 6 is a flow chart that shows the sequence of sealing and exhausting processes;

FIGS. 7(a) to 7(c) are explanatory drawings that indicate a bonding method for a vent pipe of a display panel in accordance with Embodiment 2 of the present invention;

FIGS. 8(a) and 8(b) are explanatory drawings that show the buffer bonding member in detail; and

FIG. 9 is a graph that shows the temperature profile of the sealing and exhausting processes of the display panel in accordance with Embodiment 2.

### DESCRIPTION OF THE PREFERRED EMBODIMENTS

The bonding method for a vent pipe of a display panel of the present invention can be applied to any panel as long as it has a space inside its panel and needs to evacuate the space inside of the panel through a vent hole installed in the panel and also needs to introduce a gas or the like into the space. Examples of such a display panel include a PDP and a plasma address liquid crystal (PALC) panel.

In the present invention, with respect to the vent pipe, a cylinder-shaped pipe known in the corresponding field may be used. Normally, a cylinder-shaped pipe is used as the vent pipe; however, the shape is not particularly limited to a cylinder shape as long as it allows air to pass through the pipe. With respect to the glass material, for example, alkali borosilicate glass (in general, having a softening point in a range of 600 to 700° C). is used. A flange portion having a virtually flat end face is formed on the opening of one of the ends of the vent pipe. This flange portion is formed by using a known manufacturing method. Since the end face of the flange portion is made in contact with the substrate, the end face is preferably made as flat as possible so as to prevent gas leakage or the like from the contact face.

The bonding member is a member used for bonding one end of the vent pipe to the display panel, and the bonding member may be formed by using any material, as long as it is a material that has a softening point lower than the vent pipe. However, in general, with respect to the sealing and bonding processes of the vent pipe, sealing processes of a substrate on the front face side of the display panel and a substrate on the back face side thereof are carried out simultaneously. In this sealing process, a display panel is brought into a furnace, and the temperature thereof is raised to a temperature corresponding to the softening temperature of the sealing member placed on the periphery of the substrate. Although it also depends on the material of the sealing member, the sealing temperature is approximately set in a range from 400 to 410° C. since a low melting-point glass having a low softening point is normally used as the sealing member.

Therefore, with respect to the formation of the bonding member, a glass material having a softening point (glass softening point temperature) in a range from 380 to 390° C. that is lower than the temperature of this sealing process is preferably used. This bonding member preferably contains at least one material selected from the group of oxides consisting of Pb, Si, Al, B, Li, Zn, Bi, P and Sn. With respect to the material for the bonding member, for example, a low melting-point glass frit containing PbO, SiO₂, Al₂O₃, LiO₂ or the like, a low melting-point glass frit containing a PbO-free composition such as ZnO, Bi₂O₃—B₂O₃, P₂O₅—SnO(R₂O, RO) or the like, having a softening point of about 380° C. and a thermal expansion coefficient of 72.5±5×10⁻⁷/° C., is used, and a binder resin known in the corresponding field, such as an acrylic resin, a methacrylic resin and a cellulose resin, is added to this low melting-point glass frit, and after having been press-molded into a doughnut shape having a virtually rectangular section, the resulting material is baked and used.

Preferably, the bonding member is preliminarily fitted to the periphery of the flange portion of the vent pipe and temporary secured thereto. The temporary securing process of the bonding member to the vent pipe is carried out in the following manner: after attaching the bonding member to the flange portion of the vent pipe, this is put into a heating furnace and heated at about 380° C. corresponding to the temperature at which the bonding member is softened for 10 to 30 minutes so that the bonding member is fusion-bonded to the flange portion of the vent pipe.

In the present invention, prior to carrying out the heating process to the temperature at which the bonding member is softened, the buffer member made from a low melting-point glass frit is placed on the contact face to the display panel of the flange portion of the vent pipe. The buffer member, which is a member used for alleviating an impact exerted by a contact between the flange portion of the vent pipe and the display panel, is preferably made from a material that has a glass softening-point temperature higher than the bonding member so that it is consequently softened more slowly than the bonding member. More specifically, the buffer member is preferably made from a glass material that has a softening point higher than that of the bonding member by 10%, that is, about 410° C., which is 30 to 40° C. higher than that of the bonding member. Here, the buffer member may be formed by using the same material as the bonding member.

The buffer member preferably contains at least one material selected from the group of oxides consisting of Pb, Si, Al, B, Li, Zn, Bi, P and Sn. With respect to the material for the buffer member, for example, a low melting-point glass frit containing PbO, SiO₂, Al₂O₃, LiO₂ or the like, a low melting-point glass frit containing a PbO-free composition such as ZnO, Bi₂O₃—B₂O₃, P₂O₅—SnO(R₂O, RO) or the like, having a softening point of about 410° C. and a thermal expansion coefficient of 72.5±5×10⁻⁷/° C., is used, and a binder resin known in the corresponding field, such as an acrylic resin, a methacrylic resin and a cellulose resin, is added to this low-melting point glass frit together with a solvent so that the resulting low melting-point glass paste is applied to the end face of the flange portion of the vent pipe, and then temporary baked.

Upon forming the buffer member, preferably, the corresponding material that has been press-molded into a washer-shape and baked is preliminarily temporary secured to the contact face to the display panel of the flange portion of the vent pipe, and the bonding member and the buffer member are thus preferably integrally formed with the vent pipe.

In the temporary bonding process of the buffer member to the vent pipe, after the low melting-point glass paste for the buffer member has been applied to the contact face to the display panel of the flange portion of the vent pipe, this is put into a heating furnace, and subjected to a heating process at about 380 to 390° C. for 10 to 30 minutes so that the buffer member is fusion-bonded to the contact face to the display panel of the flange portion of the vent pipe.

The present invention may have a structure in which: a ring-shaped pressing assistant member having a softening temperature higher than that of the bonding member is fitted to the periphery of the flange portion of the vent pipe so that the pressing assistant member is positioned closer to the center side of the vent pipe than the bonding member; thus, the pressure assistant member is pressed onto the display panel face by a pressing tool so that the vent pipe is secured.

The pressing assistant member is an assistant member used for pressing the bonding member and the flange portion of the vent pipe bonded to the bonding member toward the display panel side, and the pressing assistant member may be formed by using any material as long as it has a softening point higher than the bonding member and has virtually the same thermal expansion coefficient as the bonding member so as to prevent cracks. However, the material preferably has a softening point higher than the sealing temperature since, in general, the sealing process of the vent pipe is carried out simultaneously as the display panel sealing process.

Therefore, the pressing assistant member is preferably formed by using a glass material having a softening point higher than 500° C. Examples of this material include NaO- and B₂O₃-based low melting-point glasses. In addition to these, other ceramic materials may be used.

With respect to the material for the pressing buffer member, for example, a low melting-point glass frit, made from Na₂O, Al₂O₃, B₂O₃, SiO₂ or the like, having a softening point of 500° C. or more with a thermal expansion coefficient of 72.5±5×10⁻⁷/° C. that is the same as the bonding member, is used, and a binder resin known in the corresponding field, such as an acrylic resin, a methacrylic resin and a cellulose resin, is added to this low-melting point glass frit, and after having been press-molded into a doughnut-shape having a virtually rectangular section, the resulting material is baked and used. With respect to the pressing assistant member, a baked material is preferably used.

Upon temporary securing the pressing assistant member and the bonding member to the vent pipe to which the buffer member has been temporary bonded, the vent pipe is set onto a jig with the flange portion facing up, and after successively attaching the pressing assistant member and the bonding member to the flange portion of the vent pipe, the resulting structure is put in a heating furnace, and heated to a temperature in a range of 380 to 390° C. at which the bonding member is softened for 10 to 30 minutes so that the bonding member is fusion-bonded to the flange portion of the vent pipe and the pressing assistant member.

The vent pipe thus prepared is placed on the display panel in a manner so as to make the buffer member temporary bonded to the end face of the flange portion of the vent pipe in contact with the display panel so as to cover the vent hole with the opening of the vent pipe. At this time, since the buffer member temporary bonded to the end face of the flange portion is virtually flat, it is easily secured thereto.

After the flange portion or the pressing assistant member of the vent pipe has been pressed on the display panel face by a pressing tool so that the vent pipe has been secured, the resulting structure is heated to a temperature that allows the bonding member to soften so that the flange portion of the vent pipe is bonded to the display panel through the fusion of the bonding member. In this case, although any tool may be used as the pressing tool, normally, a clip is used.

The present invention also relates to a vent pipe bonded structure of a display panel in which a flange portion of the vent pipe is boned to the display panel by using the above-mentioned vent pipe bonding method for a display panel.

The present invention also relates to a vent pipe assembled body that is connected to a vent hole on a display panel so as to discharge a gas inside the panel, and has an opening that communicates with a vent hole of the display panel and is formed on one of the ends; a hollow vent pipe on which a flange portion having an end face that is made in contact with the display panel with a virtually flat end face is formed; a ring-shaped bonding member, made from glass frit, that is fitted to the periphery of the flange portion of the vent pipe, and shaped into an integral form; and a washer-shaped buffer member that is temporarily bonded to the contact face to the display panel of the flange portion of the vent pipe, and has a softening temperature that is higher than that of the bonding member.

Referring to embodiments shown in Figures, the following description will discuss the present invention in detail; however, the present invention is not intended to be limited thereby, and various modifications may be made therein.

### Embodiment 1

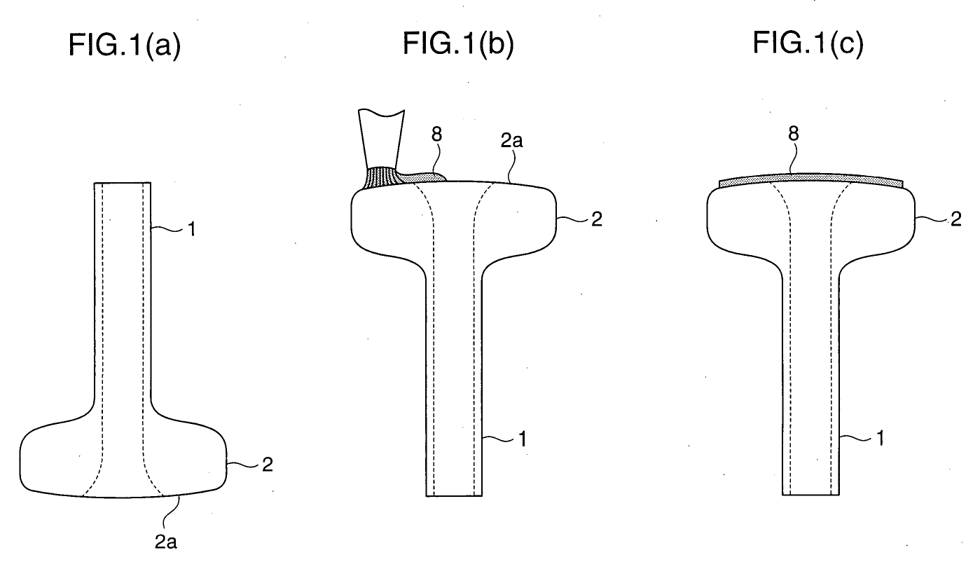

FIGS. 1(a) to 1(c), FIGS. 2(a) and 2(b) and FIG. 3 are explanatory drawings that show a bonding method for a vent pipe of a display panel in accordance with Embodiment 1 of the present invention.

First, as shown in FIGS. 1(a) to 1(c), a vent pipe 1, which has a flange portion 2 having a virtually flat end face 2a that is formed on the opening of one end of the cylinder-shaped vent pipe 1, is used (see FIG. 1(a)).

A washer-shaped (flat doughnut-shaped) buffer member 8 is temporary bonded to the end face 2a of the flange portion 2 of the vent pipe 1. This buffer member 8 is formed by applying a low melting-point glass paste made from a low melting-point glass frit, a binder resin and a solvent thereto (see FIG. 1(b)) to be dried and temporary baked thereon (see FIG. 1(c)).

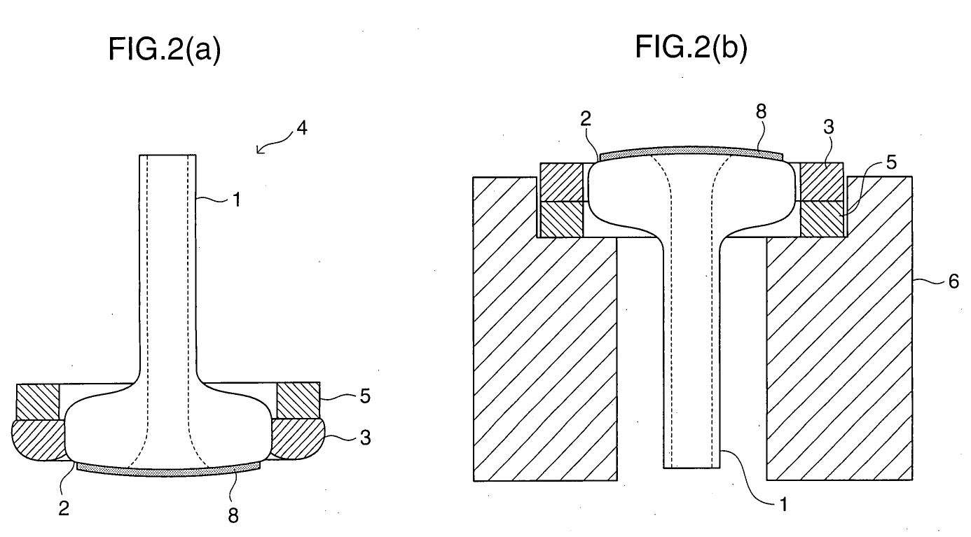

Next, as shown in FIG. 2(a), a ring-shaped bonding member 3 and a ring-shaped pressing assistant member 5 having a higher softening temperature than the bonding member 3 are temporary bonded to the periphery of the flange portion 2 of the vent pipe 1 from one end thereof in this order so that a vent pipe assembly 4 to which the buffer member 8, the bonding member 3 and the pressing assistant member 5 have been integrally attached to the vent pipe 1 is preliminarily formed. The manufacturing method of this will be described later.

The vent pipe 1 is a cylinder-shaped pipe made of normal alkali borosilicate glass (softening point 600 to 700° C.).

The bonding member 3 is made of a molded glass material prepared by processes in which a binder resin is mixed in a low melting-point glass frit to be molded, and then baked. In other words, the bonding member 3 is prepared by processes in which: a low-melting point glass frit, made from PbO, SiO₂, Al₂O₃, B₂O₃, LiO₂ or the like, having a softening point of about 380° C. with a thermal expansion coefficient of 72.5±5×10⁻⁷/° C. is used and a binder resin known in the corresponding field is added to this low-melting point glass frit so that the resulting material is press-molded into a doughnut shape with a section having a virtually rectangular shape.

With respect to the buffer member 8, a binder resin known in the corresponding field and a solvent are added to a low melting-point glass frit, made from PbO, SiO₂, B₂O₃, ZnO or the like, having a softening point of about 410 to 420° C. with a thermal expansion coefficient of 72.5±5×10⁻⁷/° C., to prepare low melting-point glass in a paste state, and this glass paste is used. The softening point of the buffer member 8 is set to 30 to 40° C. higher than the softening point of the bonding member 3. With respect to the buffer member 8, a molded glass material, prepared by processes in which a binder resin is mixed in a low melting-point glass frit and after having been press-molded into a washer shape, the resulting material is sintered, may be used.

The pressing assistant member 5 is prepared by processes in which: a low-melting point glass frit, made from Na₂O, Al₂O₃, B₂O₃, SiO₂ or the like, having a softening point of about 500° C. with a thermal expansion coefficient of 72.5±5×10⁻⁷/° C. that is the same as the bonding member 3, is used and a binder resin known in the corresponding field is added to this low-melting point glass frit so that the resulting material is press-molded into a doughnut shape with a section having a virtually rectangular shape.

Upon forming the vent pipe assembly 4, first, the vent pipe 1 to which the buffer member 8 has been temporary bonded is set onto a jig 6 with the flange portion 2 facing up, next, the ring-shaped pressing assistant member 5 is put on the jig 6 on the periphery of the flange portion 2 to be set, and the bonding member 3 is then set thereon (see FIG. 2(b)). The resulting structure in this state is put in a heating furnace, and heated to soften the bonding member 3 so that the bonding member 3 is bonded to the periphery of the flange portion 2; thus, the pressing assistant member 5 is then bonded to the bonding member 3 to form the vent pipe assembly 4 (see FIG. 2(a)).

The thickness of the pressing assistant member 5 is made thinner than the thickness of the flange portion 2 in the length direction of the vent pipe 1. Moreover, the joint thickness of the bonding member 3 and the pressing assistant member 5 is made thicker than the thickness of the flange portion 2 in the length direction of the vent pipe 1.

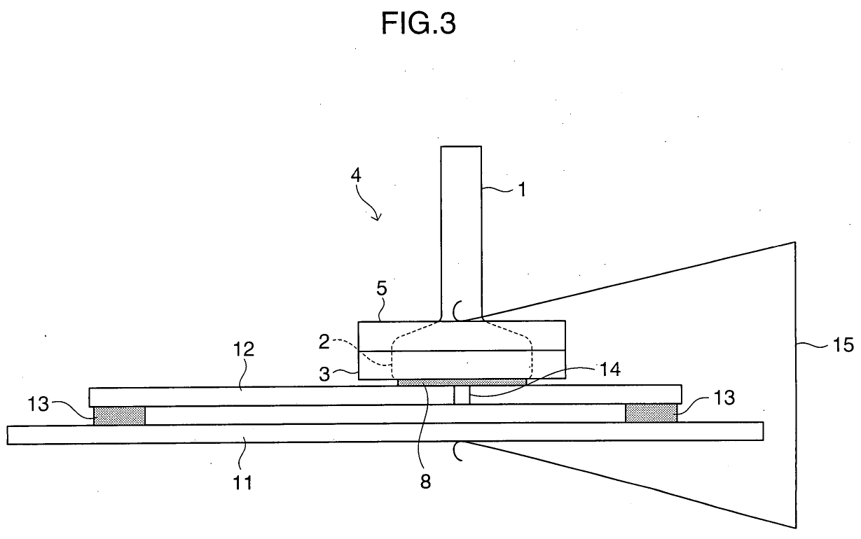

As shown in FIG. 3, upon sealing the periphery of a substrate 11 of the front face side and the periphery of a substrate 12 on the back face side with sealing member 13 composed of low melting-point glass serving as the base member (sealing and exhausting processes), the vent pipe assembly 4 is placed at a position of a vent hole 14 on the substrate 12 on the back face side. In this case, the buffer member 8, temporary bonded to the end face 2a of the flange portion 2 of the vent pipe 1, is made in contact with the substrate 12 on the back face side so that the vent hole 14 is covered with the opening of the vent pipe 1.

After this positioning process, with the pressing assistant member 5 and the display panel being sandwiched by a clip 15, the vent pipe 1 is secured in such a manner that the bonding member 3 and the flange portion 2 of the vent pipe 1 that has been bonded thereto are pressed onto the display panel side. Upon this pressing process, a number of portions on the periphery of the display panel are clamped with clips of the same kind.

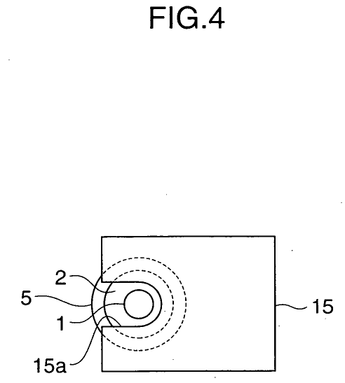

FIG. 4 is a plan view that shows a state in which the vent pipe 1 and the display panel are sandwiched by the clip 15. As shown in this Figure, the clip 15 has a cut-out 15a so as to press both of the flange portion 2 of the vent pipe 1 and the pressure assistant member 5.

Next, while the vent pipe 1 and the display panel are being sandwiched by the clip 15 in this manner, sealing and exhausting processes of the display panel are carried out. In these sealing and exhausting processes, the display panel is put into a sealing-exhausting furnace, and a baking process is carried out at a temperature in a range of 400 to 410° C. that corresponds to the softening temperature of the sealing member 13 so that the sealing member 13 on the periphery of the display panel is softened to seal the substrate 11 on the front face side and the substrate 12 on the back face side. The vent pipe 2 is made from alkali borosilicate glass, and has a softening point in a range of 600 to 700° C. Moreover, the substrate 11 on the front face side and the substrate 12 on the back face side are made of glass having a high strain point with a softening point in a range of about 750 to 850° C. Therefore, the vent pipe 2, the substrate 11 on the front face side and the substrate 12 on the back face side are not softened in this heating temperature (400 to 410° C.).

By this heating process, the bonding member 3 is also softened so that the flange portion 2 of the vent pipe 1 is bonded to the substrate 12 on the back face side through the fusion of the bonding member 3. At this time, the buffer member 8 is softened more slowly than the bonding member 3 so that the buffer member 8 alleviates the contact between the end face 2a of the flange portion 2 of the vent pipe 1 and the display panel, with the result that, for example, even if there is a foreign matter between them or even if a positional deviation occurs, it becomes possible to prevent the end face 2a from scratches.

Moreover, the buffer member 8 is also slightly softened, and by the softened buffer member 8, gaps on the contact face between the end face 2a of the flange portion 2 of the vent pipe 1 and the display panel are sealed so that the bonding member 3 in the softened state is blocked from entering the opening of the vent pipe and the vent hole of the display panel so that the opening of the vent pipe and the vent hole of the display panel are prevented from being blocked. In this case, since the viscosity of the buffer member 8 is kept higher than the viscosity of the bonding member 3, the buffer member 8 is prevented from entering the opening of the vent pipe and the vent hole of the display panel.

In this state, the base plate 11 on the front face side and the substrate 12 on the back face side are sealed, with the vent pipe 1 being bonded to the substrate 12 on the back face side, so that an impurity gas is drawn from the inside of the panel while the inside of the panel is filled with a charging gas; thereafter, the vent pipe is fused and cut in a manner so as to block the vent path of the vent pipe 1 so that the charging space is tightly closed.

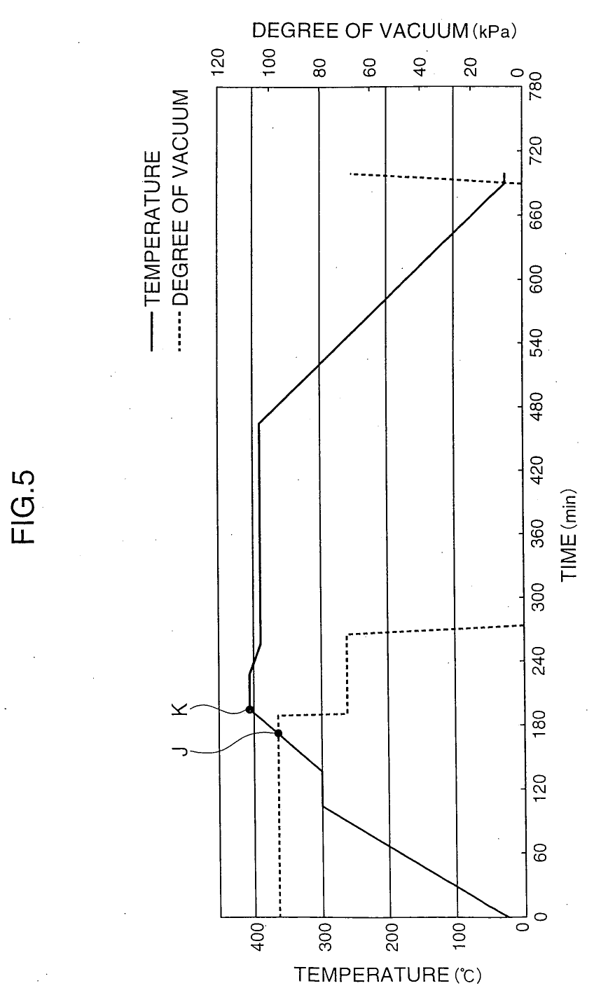

FIG. 5 is a graph that shows the temperature profile of the sealing and exhausting processes of the display panel of Embodiment 1. The solid line indicates the temperature, and the broken line indicates the degree of vacuum.

The heating process is carried out so that the temperature is maintained constant at 300° C. for 30 to 40 minutes, and then raised to 410° C., and after a lapse of little period of time, is gradually dropped to 390° C.; thus, this temperature is maintained for 240 minutes, and then naturally cooled off.

In the graph, softening of the bonding member 3 starts at the time of J, and softening of the buffer member 8 and the sealing member 13 starts at the time of K. Although the exhausting process is started simultaneously with the start of the heating process, the degree of vacuum starts actually rising at the time of K at which the sealing member 13 starts melting. When the degree of vacuum increases, the inside of the display panel is set to a negative pressure, with the result that a suction force is exerted between the substrate on the front face side and the substrate on the back face side to apply a pressure on the sealing member 13.

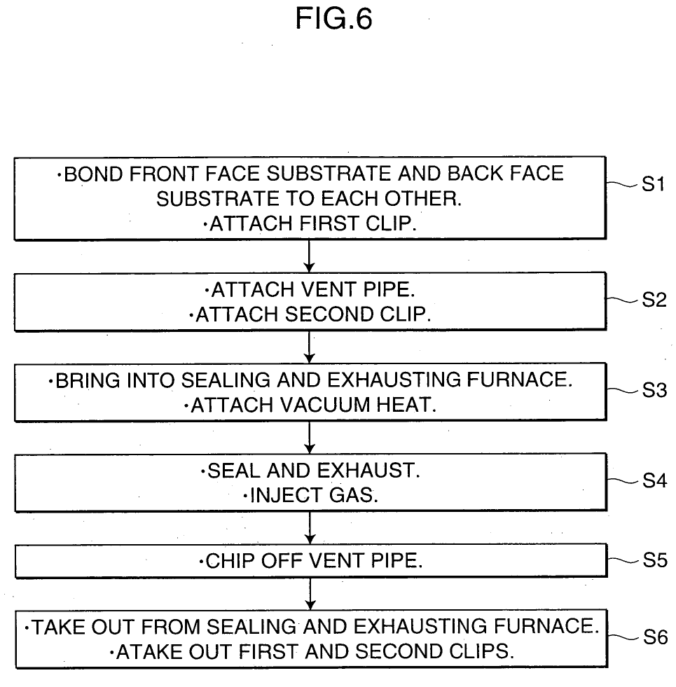

Referring to a flow chart shown in FIG. 6, the following description will discuss the sequence of sealing and exhausting processes.

First, the substrate 11 on the front face side and the substrate 12 on the back face side are superposed on each other, and fixed by a first clip (step S1), and the vent pipe 1 is placed and fixed by a second clip (step S2); next, a display panel is carried into a sealing and exhausting furnace, and a vacuum head is attached to the vent pipe 1 (step S3), and after sealing and exhausting processes have been carried out, a charging gas is injected thereto (step S4), and the vent pipe 1 is subjected to a chipping-off process (step S5) so that the display panel is taken out from the sealing and exhausting furnace and the first and second clips are removed (step S6).

### Embodiment 2

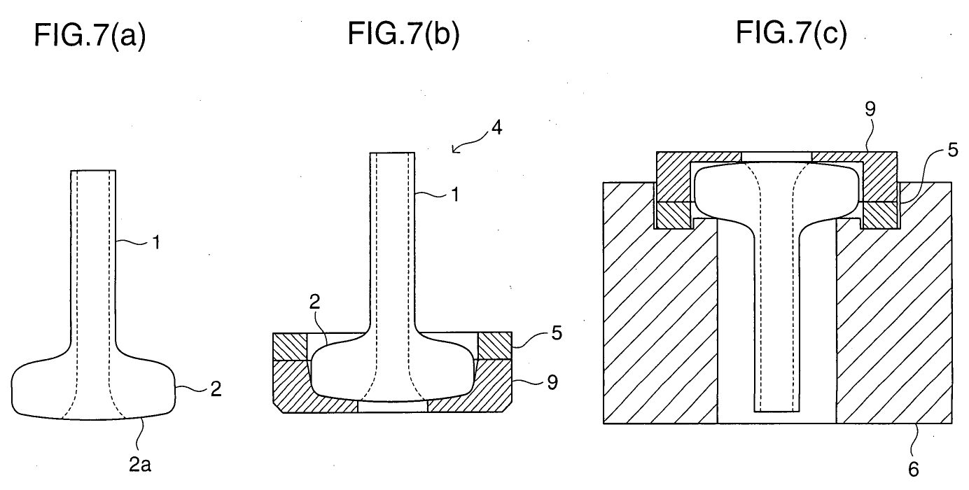

FIG. 7 is an explanatory drawing that indicates a bonding method for a vent pipe of a display panel in accordance with Embodiment 2 of the present invention.

In the present embodiment, the buffer member 8 and bonding member 3 of Embodiment 1 are integrally formed into a single unit and used as a buffer bonding member 9. This buffer bonding member 9 is formed by using the same material as the bonding member 3 of Embodiment 1.

As shown in FIGS. 7(a) to 7(c), by using the same vent pipe 1 as Embodiment 1 (see FIG. 7(a)), the buffer bonding member 9 having a disc shape is used, and the buffer bonding member 9 is attached to the periphery of the flange portion 2 of the vent pipe 1. Moreover, the same pressing assistant member 5 as Embodiment 1 is temporary bonded to the buffer bonding member 9, and the buffer bonding member 9 and the pressure assistant member 5 are attached to the vent pipe 1 to form an integral unit so that a vent pipe assembly 4 is preliminarily manufactured (see FIG. 7(b)).

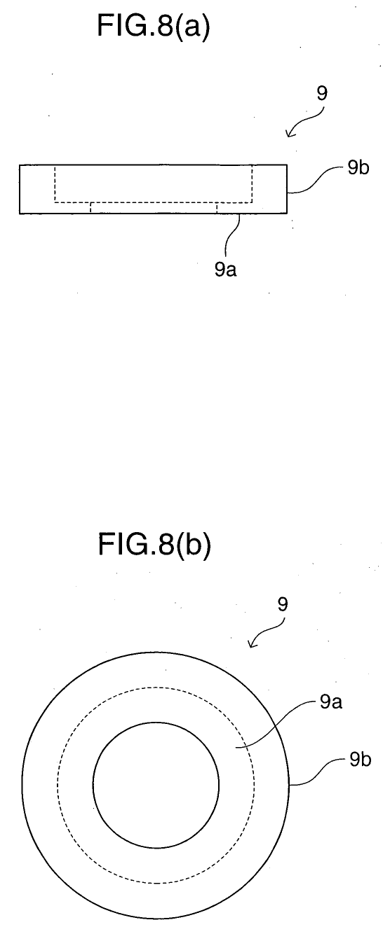

FIGS. 8(a) and 8(b) are explanatory drawings that show the buffer bonding member in detail.

The buffer bonding member 9 has a disc shape constituted by a buffer face 9a and a ring portion 9b. The ring portion 9b is formed so as to be detachably attached to the periphery of the flange portion 2 of the vent pipe 1. The buffer face 9a is designed so that when the ring portion 9b is attached to the periphery of the flange portion 2 of the vent pipe 1, it covers the contact face to the display panel of the flange portion 2 of the vent pipe 1.

Upon forming the vent pipe assembly 4, first, the vent pipe 1 is set onto a jig 6 with the flange portion. 2 facing up, next, the ring-shaped pressing assistant member 5 is put on the jig 6 on the periphery of the flange portion 2 to be set, and the buffer bonding member 9 is then set thereon (see FIG. 7(c)). The resulting structure in this state is put in a heating furnace, and heated to soften the buffer bonding member 9 so that the buffer bonding member 9 is bonded to the periphery of the flange portion 2; thus, the pressing assistant member 5 is then bonded to the buffer bonding member 9 to form the vent pipe assembly 4 as shown in FIG. 7(b)).

With respect to the sealing and exhausting processes, the same processes as those of Embodiment 1 are carried out.

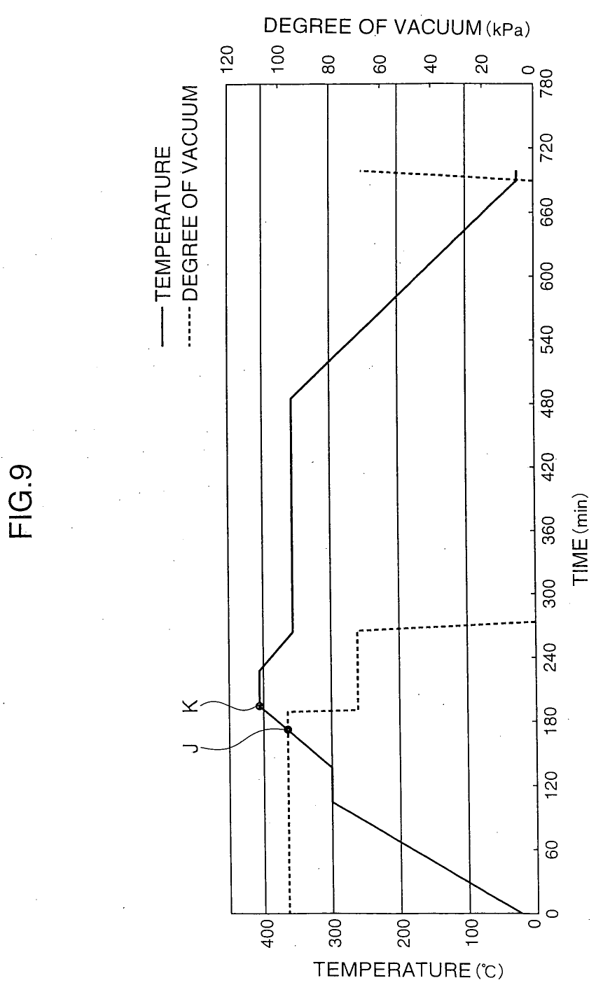

FIG. 9 is a graph that shows the temperature profile of the sealing and exhausting processes of the display panel in accordance with Embodiment 2. The solid line indicates the temperature, and the broken line indicates the degree of vacuum.

Although the sealing and exhausting processes are carried out in the same manner as Embodiment 1, the temperature profile of the sealing and exhausting processes are slightly different from that of Embodiment 1 because the buffer bonding member 9 is used.

The heating process is carried out in the following manner: the temperature is maintained constant at 300° C. for 30 to 40 minutes, and then raised to 410° C., and after a lapse of little period of time, is gradually dropped to 350° C.; thus, this temperature is maintained for 240 minutes, and then naturally cooled off.

As described above, in the heating process for exhausting, after having been heated to 410° C. that corresponds to the softening temperature of the sealing member 13, the panel temperature is set to 380° C. or less that corresponds to the softening point of the buffer bonding member, preferably, to about 350° C., so that the high viscosity of the buffer bonding member is maintained.

In the graph, softening of the buffer bonding member 9 starts at the time of J, and softening of the sealing member 13 starts at the time of K. Although the exhausting process is started simultaneously with the start of the heating process, the degree of vacuum starts actually rising at the time of K at which the sealing member 13 starts melting. The sequence of the sealing and exhausting processes is the same as the flow chart shown in Embodiment 1.

The following description will discuss Examples. Explanations relating to Embodiment 1 are given as Example 1, and explanations relating to Embodiment 2 are given as Example 2.

### EXAMPLE 1

A vent pipe in which one end of a glass tube was formed into a flange shape having a virtually flat end face, a low melting-point glass frit used as a buffer member, a bonding member and a pressing assistant member, formed into a ring shape, were prepared.

The bonding member formed into the ring shape had a softening point of about 380° C., the pressing assistant member had a softening point of about 500° C., and the low melting-point glass frit used for a buffer member had a softening point of about 410° C.

First, a low melting-point glass frit used for the buffer member was applied to the end face of the flange portion of the vent pipe. This applying process was carried out by using a dispensing method, or an applying method using a blade. The thickness of the coat film was set in a range from 200 μm to 500 μm with a pattern width of about 1 mm.

Next, the vent pipe coated with a low melting-point glass frit for the buffer member was temporary baked to remove resin components from the low melting-point glass frit and the low melting-point glass was softened to be integrally formed with the vent pipe so that the vent pipe with the buffer member was prepared. At this time, the temporary baking process was carried out at 400° C. for about 30 minutes.

Thereafter, a bonding member was fitted to the flange portion of the vent pipe on the panel side of the flange portion of the vent pipe with a pressing assistant member being fitted to the opposite side to the panel, and this was baked at a temperature ranging from 380° C. to 390° C. so that the vent pipe, the bonding member and the pressing assistant member were integrally formed into a single unit through the softened bonding member.

The vent pipe assembly thus formed was placed in a manner so as to cover the vent hole formed on the back face side of the display panel, and clamped by a clip. This was then subjected to heating processes for sealing and exhausting the display panel so that a PDP panel was manufactured.

### EXAMPLE 2

A vent pipe in which one end of a glass tube was formed into a flange shape having a virtually flat end face, a buffer bonding member formed into a disc shape and a pressing assistant member, formed into a ring shape, were prepared.

The buffer bonding member formed into a disc shape was molded so as to be made in contact with the side face of the flange portion of vent pipe as well as with the face of the flange portion on the display panel side.

The buffer bonding member formed into the ring shape had a softening point of about 380° C., and the pressing assistant member had a softening point of about 500° C.

Thereafter, a buffer bonding member was fitted to the flange portion of the vent pipe on the panel side of the flange portion of the vent pipe with a pressing assistant member being fitted to the opposite side to the panel, and this was baked at a temperature ranging from 380° C. to 390° C. so that the vent pipe, the buffer bonding member and the pressing assistant member were integrally formed into a single unit through the softened buffer bonding member.

The vent pipe thus formed was placed in a manner so as to cover the vent hole formed on the back face side of the display panel, and clamped by a clip. This was then subjected to heating processes for sealing and exhausting the display panel so that a PDP panel was manufactured.

As described above, by placing the buffer member on the contact face to the display panel of the flange portion of the vent pipe, the buffer member exerts a buffering function upon carrying out sealing and exhausting processes of the display panel so that it becomes possible to prevent the end face of the flange portion of the vent pipe from directly contacting the glass substrate and consequently to avoid scratches on the flange portion of the vent pipe or cracks on the flange portion. Moreover, since the buffer member is made from a glass frit having a low melting-point temperature that has a softening temperature higher than that of the bonding member, the viscosity of the buffer member is not lowered upon heating treatment for sealing and exhausting processes of the display panel, and a high viscosity is maintained so that it becomes possible to prevent the opening of the vent pipe and the vent hole of the display panel from being blocked.

Moreover, the buffer bonding member in which the buffer member and bonding member are integrally formed may be placed on the contact face to the display panel of the flange portion of the vent pipe so that the same effects can be obtained.

1. A bonding method for a vent pipe of a display panel, which positions a tube-shaped vent pipe having a flange portion with a virtually flat end face at one end thereof to a vent hole of a display panel and bonds the vent pipe thereto through a fused bonding member, comprising the steps of:
preparing the bonding member on the periphery of the flange portion of the vent pipe;
interposing a buffer member made of a low-melting point glass flit having a softening temperature higher than that of the bonding member between a contact face to the display panel of the flange portion of the vent pipe and the display panel; and
in a state in which the flange portion of the vent pipe is pressed onto the display panel face by a pressing member so that the vent pipe is fixed, heating the bonding member and the buffer member to a temperature to be softened so that the flange portion of the vent pipe is bonded to the display panel through the fused bonding member.

2. A bonding method for a vent pipe of a display panel comprising the steps of:
preparing a tube-shaped vent pipe having a flange portion with a virtually flat end face at one end thereof and a ring-shaped bonding member;
fitting the bonding member to the periphery of the flange portion of the vent pipe;
making the vent pipe in contact with the display panel having a vent hole, with the end face of the flange portion of the vent pipe being made in contact with the display panel, to arrange so that the vent hole is covered with the opening of the vent pipe;
after pressing the flange portion of the vent pipe to the display panel face by a pressing member to secure the vent pipe thereto, carrying out a heating process to a temperature at which the bonding member is softened so that the flange portion of the vent pipe is bonded to the display panel through the fused bonding member; and
prior to carrying out the heating process to the temperature that allows the bonding member to soften, placing a washer-shaped buffer member made from a low melting-point glass frit onto a contact face to the display panel of the flange portion of the vent pipe.

3. The bonding method according to claim 1, wherein: the bonding member is preliminarily fitted to the periphery of the flange portion of the vent pipe to be temporarily secured thereto and the buffer member is preliminary temporarily bonded to the contact face to the display panel of the flange portion of the vent pipe, with the bonding member and the buffer member being consequently formed into an integral unit.

4. The bonding method according to claim 1, wherein the buffer member has a glass softening point temperature higher than that of the bonding member so as to be more slowly softened than the bonding member.

5. The bonding method according to claim 4, wherein the glass softening point temperature of the buffer member is higher than the glass softening point temperature of the bonding member by approximately 10%.

6. The bonding method according to claim 1, wherein the buffer member is formed by using the same material as the bonding member.

7. The bonding method according to claim 1, wherein each of the bonding member and the buffer member contains at least one oxide selected from the group consisting of Pb, Si, Al, B, Li, Zn, Bi, P and Sn oxides.

8. A vent pipe bonded structure of a display panel, wherein a flange portion of the vent pipe is connected to the display panel by using at least one method according to claim 1.

9. A vent pipe assembled body, which is connected to a vent hole on a display panel so as to discharge a gas inside the panel, comprising:
an opening that communicates with a vent hole of the display panel and is formed on one of the ends;
a hollow vent pipe on which a flange portion having an end face that is made in contact with the display panel with a virtually flat end face;
a ring-shaped bonding member, made from glass frit, that is fitted to the periphery of the flange portion of the vent pipe, and shaped into an integral form; and
a washer-shaped buffer member that is temporarily bonded to the contact face to the display panel of the flange portion of the vent pipe, and has a softening temperature that is higher than that of the bonding member.

10. The bonding method according to claim 2, wherein: the bonding member is preliminarily fitted to the periphery of the flange portion of the vent pipe to be temporarily secured thereto and the buffer member is preliminary temporarily bonded to the contact face to the display panel of the flange portion of the vent pipe, with the bonding member and the buffer member being consequently formed into an integral unit.

11. The bonding method according to claim 2, wherein the buffer member has a glass softening point temperature higher than that of the bonding member so as to be more slowly softened than the bonding member.

12. The bonding method according to claim 2, wherein the buffer member is formed by using the same material as the bonding member.

13. The bonding method according to claim 2, wherein each of the bonding member and the buffer member contains at least one oxide selected from the group consisting of Pb, Si, Al, B, Li, Zn, Bi, P and Sn oxides.
